(19) United States
(12) Patent Application Publication
(10) Pub. No.: US 2012/0165035 A1
(43) Pub. Date: Jun. 28, 2012

(54) FACILITATING AD HOC CONGREGATION OVER AN INSTANT MESSAGING NETWORK

(75) Inventors: Henry Yao-Tsu Chen, Waterloo (CA); Theban Ganeshalingam, Mississauga (CA)

(73) Assignee: Research In Motion Limited, Waterloo (CA)

(21) Appl. No.: 12/975,594

(22) Filed: Dec. 22, 2010

(51) Int. Cl. H04W 24/00; H04W 4/02

(52) U.S. Cl. 455/456.1

(57) ABSTRACT

Facilitating ad-hoc congregation using an application on a wireless mobile device is provided. Geographic locations defined as meet-ups are shared with members of group. When a wireless mobile device of one of the members of the group enters the geographic location of the meet-up, the wireless mobile device sends a meet-up notification message via a wireless network to other members of the group to identify it's presence at the pre-defined location. Group members can then decide to proceed to the meet-up location based upon the received notification messages.

### TECHNICAL FIELD

The present disclosure relates to instant messaging and in particular to location related messaging between wireless mobile devices.

### BACKGROUND

Instant messaging applications have provided the ability for communication between two or more users quickly between electronic devices. The use of instant messaging applications on mobile wireless devices, such as for example Blackberry Messenger™, has enabled users to connect and stay in contact with groups of people via deliver text, audio and video based messages no matter where they are. The inclusion of location identification capabilities in wireless mobile devices, using technologies such as Global Positioning System (GPS), have enabled information to be delivered to the devices based upon their location. Wireless mobile devices can determine their location with considerable accuracy but have primarily been limited to mapping and navigation applications. The advent of instant messaging and social networking applications have spawned an increased desire to be aware of the activities and locations of friends.

Accordingly, systems and methods that enable ad hoc congregation by using an instant messaging network between wireless mobile devices remain highly desirable.

### BRIEF DESCRIPTION OF THE DRAWINGS

Further features and advantages of the present disclosure will become apparent from the following detailed description, taken in combination with the appended drawings, in which:

FIG. 1 shows a schematic representation of wireless mobile device;

FIG. 2 shows a schematic representation of a wireless instant messaging system;

FIG. 3 shows an example device screen providing an instant messaging application;

FIG. 4 shows an example device screen providing an instant messaging application identifying shared meet-up locations;

FIG. 5 shows an example device screen providing an instant messaging application identifying check-in status at a shared meet-up location;

FIG. 6 shows an example device screen providing an instant messaging application identifying a shared meet-up location map;

FIG. 7 shows an alternative example device screen providing an instant messaging application identifying shared meet-up locations;

FIGS. 8a & 8b show a flow diagrams illustrating a shared meet-up location check-in on a wireless mobile device;

FIG. 9 shows a flow diagram illustrating a shared meet-up location check-in on an instant messaging server;

FIG. 10 shows a flow diagram illustrating an alternative shared meet-up location check-in on an instant messaging server;

FIG. 11 shows a flow diagram illustrating a shared meet-up notification being received by a member wireless mobile device;

FIG. 12 shows a flow diagram illustrating a shared meet-up location request generation on a wireless mobile device;

FIG. 13 shows a flow diagram illustrating a shared meet-up location request acceptance on a wireless mobile device; and

FIG. 14 shows a flow diagram illustrating a shared meet-up location request processing on an instant messaging server.

It will be noted that throughout the appended drawings, like features are identified by like reference numerals.

### DETAILED DESCRIPTION

The details and particulars of these aspects of the technology will now be described below, by way of example, with reference to the attached drawings.

In accordance with an aspect of the present disclosure there is provided a method of facilitating ad-hoc congregation using an application executed by a processor on a wireless mobile device. The method comprising: determining a current position of the wireless mobile device; determining if the current position of the wireless mobile device is at a shared meet-up location; and sending a meet-up notification message via a wireless network to members defined by a group to identify that the wireless device is currently at the shared meet-up location.

In accordance with another aspect of the present disclosure there is provided a wireless mobile device comprising a positioning device for determining the position of the wireless mobile device; a wireless transceiver for communicating with a wireless network; a memory containing instructions for facilitating ad-hoc congregation using an application executed by a processor on a wireless mobile device; a processor coupled to the location device, wireless transceiver and the memory, the processor executing an application comprising: determining a current position of the wireless mobile device; determining if the current position of the wireless mobile device is at a shared meet-up location; and sending a meet-up notification message via a wireless network to members defined by a group to identify that the wireless device is currently at the shared meet-up location.

In accordance with yet another aspect of the present disclosure there is provided a computer readable memory containing instructions for facilitating ad-hoc congregation using an application executed by a processor on a wireless mobile device. The instructions when executed by the processor providing: determining a current position of the wireless mobile device; determining if the current position of the wireless mobile device is at a shared meet-up location; and sending a meet-up notification message via a wireless network to members defined by a group to identify that the wireless device is currently at the shared meet-up location.

This disclosure seeks to facilitate physical interactions among a collection of people who normally have sites of congregation such as the shopping mall, grocery store, coffee shop, neighbourhood playground. Occasionally, meet-ups at these sites are arranged. On other occasions, arrival at the site is unplanned. The term instant messaging is used in the disclosure and also includes a peer-to-peer messaging system. Instant messaging includes any type of real-time or near real-time communication applications utilizing direct communication between devices or utilizing one or more servers for facilitating communication. The disclosed technology enables congregation at designated sites in an ad-hoc manner based upon instant messaging communications. A group defining multiple members (or users), such as those defined in instant messaging applications, can designate meet-up sites defined by a geographic location. When members arrive at a designated meet-up site, this information can be shared with the members of the group enabling members to know who is at the designed meet-up site. Users can adjust their schedules and congregate there as well, knowing that this group desires social contact at the designated location.

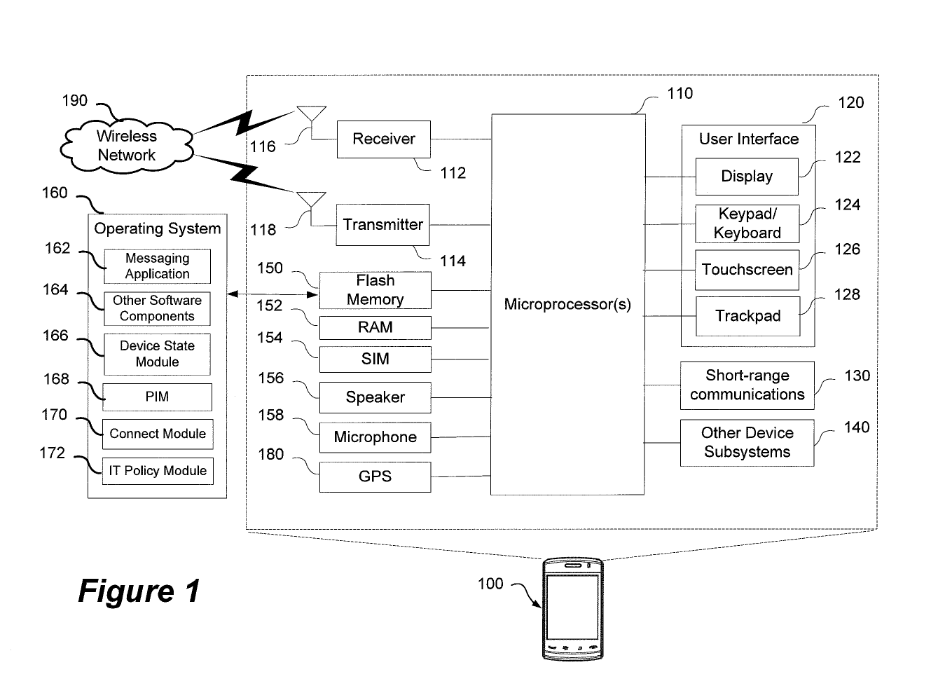

FIG. 1 is a schematic depiction of a wireless communications device as one example of a wireless mobile device on which the present technology may be implemented. As shown by way of example in FIG. 1, the wireless mobile device, which is designated generally by reference numeral 100, includes a processor (or microprocessor) 110 for executing one or more applications, memory in the form of flash memory 120 and/or Flash memory 150 and RAM 152 (or any equivalent memory devices) for storing the one or more applications and related data, and a user interface 120 with which the user interacts with the device. The user interface 140 may include a display 122 and an alphanumeric keypad/keyboard 124 and/or touch screen 126. The device may include a trackball, thumbwheel or trackpad 128 for cursor movement and navigation.

As shown by way of example in FIG. 1, the wireless mobile device 100 includes a radiofrequency (RF) transceiver comprising a receiver 122 and associated receiver antenna 166 and transmitter 144 and associated transmitter antenna 118. The RF transceiver for communication with a wireless network 190 using a wireless communication protocols such as, for example but not limited to, GSM, UMTS, LTE, HSPDA, CDMA, W-CDMA, Wi-MAX, etc. A subscriber identify module (SIM) card 154 may be provided. Optionally, where the device is a voice-enabled wireless communications device such as, for example, a smartphone or cell phone, the device would further include a microphone 158 and a speaker 156. Short-range communications is provided through wireless technologies such as Bluetooth™ or wired Universal Serial Bus™ connections to other peripheries or computing devices or by other device sub-systems 140. This device may optionally include a Global Positioning System (GPS) receiver chipset 180 or other location-determining subsystem.

Although the present disclosure refers to expressly to the “Global Positioning System”, it should be understood that this term and its abbreviation “GPS” are being used expansively to include any satellite-based navigation-signal broadcast system, and would therefore include other systems used around the world including the Beidou (COMPASS) system being developed by China, the multi-national Galileo system being developed by the European Union, in collaboration with China, Israel, India, Morocco, Saudi Arabia and South Korea, Russia's GLONASS system, India's proposed Regional Navigational Satellite System (IRNSS), and Japan's proposed QZSS regional system.

Another sort of position-determining subsystem may be used as well, e.g. a radiolocation subsystem that determines its current location using radiolocation techniques, as will be elaborated below. In other words, the location of the device can be determined using triangulation of signals from in-range base towers, such as used for Wireless E911. Wireless Enhanced 911 services enable a wireless mobile device or other wireless device to be located geographically using radiolocation techniques such as (i) angle of arrival (AOA) which entails locating the caller at the point where signals from two towers intersect; (ii) time difference of arrival (TDOA), which uses multilateration like GPS, except that the networks determine the time difference and therefore the distance from each tower; and (iii) location signature, which uses “fingerprinting” to store and recall patterns (such as multipath) which mobile phone signals exhibit at different locations in each cell. Radiolocation techniques may also be used in conjunction with GPS in a hybrid positioning system. References herein to “GPS” are meant to include Assisted GPS and Aided GPS.

The mobile device 100 also includes an operating system 160 and software components 162 to 172 which are described in more detail below. The operating system 160 and the software components 162 to 172 that are executed by the main processor 110 are typically stored in a persistent store such as the flash memory 150, which may alternatively be a read-only memory (ROM) or similar storage element (not shown). Those skilled in the art will appreciate that portions of the operating system 160 and the software components 162 to 172, such as specific device applications, or parts thereof, may be temporarily loaded into a volatile store such as the RAM 152. Other software components can also be included, as is well known to those skilled in the art.

The subset of software applications that control basic device operations, including data and voice communication applications, may be installed on the mobile device 100 during its manufacture. Other software applications include a message application 162 that can be any suitable software program that allows a user of the mobile device 100 to send and receive electronic messages. Various alternatives exist for the message application 162 as is well known to those skilled in the art. Messages that have been sent or received by the user are typically stored in the flash memory 150 of the mobile device 100 or some other suitable storage element in the mobile device 100. In at least some embodiments, some of the sent and received messages may be stored remotely from the device 100 such as in a data store of an associated host system that the mobile device 100 communicates with.

The software applications can further comprise a device state module 166, a Personal Information Manager (PIM) 168, and other suitable modules (not shown). The device state module 166 provides persistence, i.e. the device state module 166 ensures that important device data is stored in persistent memory, such as the flash memory 150, so that the data is not lost when the mobile device 100 is turned off or loses power. The PIM 168 includes functionality for organizing and managing data items of interest to the user, such as, but not limited to, e-mail, contacts, calendar events, voice mails, appointments, and task items.

The mobile device 100 may also comprise a connect module 170, and an IT policy module 172. The connect module 170 implements the communication protocols that are required for the mobile device 100 to communicate with the wireless infrastructure and any host system, such as an enterprise system, that the mobile device 100 is authorized to interface with.

The connect module 170 includes a set of APIs that can be integrated with the mobile device 100 to allow the mobile device 100 to use any number of services associated with the enterprise system. The connect module 170 allows the mobile device 100 to establish an end-to-end secure, authenticated communication pipe with the host system. A subset of applications for which access is provided by the connect module 170 can be used to pass IT policy commands from the host system to the mobile device 100. This can be done in a wireless or wired manner. These instructions can then be passed to the IT policy module 172 to modify the configuration of the device 100.

Some examples of other software components 164 that may be executed by the operating system 160 may include, instant messaging application, social networking, mapping, internet browser, searching, calendar, address book and phone applications. It will be appreciated that the various applications may operate independently or may utilize features of other applications. For example, the phone application and messaging application may use the address book for contact details. The instant messaging application comprises or otherwise has access to an instant messaging (IM) message store, which is used to store instant messages and instant messaging sessions or conversations comprising one or more messages exchanged with a particular correspondent or contact. The instant messaging application comprises or otherwise has access to an IM contact list which may or may not be a subset of the contacts in the address book. The IM contact list comprises the contact with which the user of the mobile device 100 can engage in an instant messaging conversation.

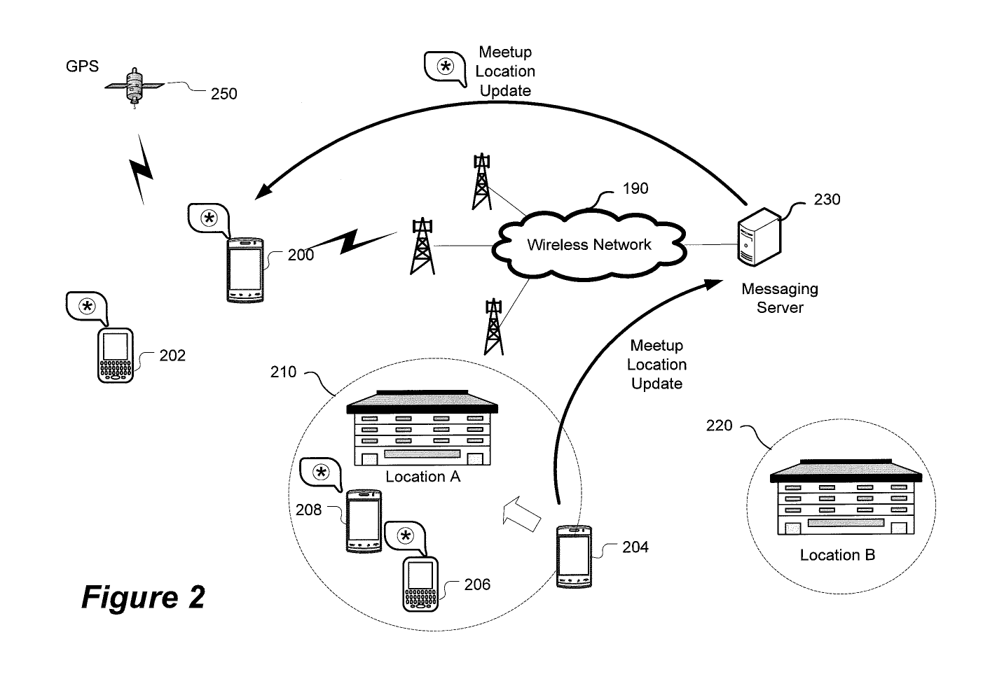

Referring to FIG. 2 shows a schematic representation of an instant messaging system. In an IM application, members defined by the contact lists relate to each virtually through sending text messaging or other media content. There are occasions where physical interactions might be desirable and users may want to know when members of their social group are at designated locations. In the example presented in FIG. 2, wireless mobile devices 200 to 208 are identified as members in a group in a messaging application. The wireless devices can be smart phones, tablet computer, or any wireless computing device. The group has defined meet-up locations such as location A 210 and location B 220. The location A 210, for example a coffee shop, and location B 220, for example a café, can be defined as geographic positioning coordinate or a range of coordinates defining a meeting are or meeting place. When a respective wireless mobile device enters the area of a meet-up location, for example wireless mobile device 204 arriving at Location A 210, a location update is sent to a messaging server 230 to be distributed to other members of the group. The location update may include a GPS location or a pre-defined location or meet-up identifier. The location updated may also include a group identifier or individual member identifiers for distribution of the location update. The server 230 can then determine the devices 200, 202, 206 and 208 to which meeting updates are to be distributed to. The server 230 may be coupled to other communication subsystems to determine a destination device or network to locate a respective recipient wireless mobile device. The server includes a least a processor and a memory, however the functionality of the server may be incorporated into other networking or computing devices, or may be implemented using the functionality of multiple computing devices. The server 230 can then update the status of wireless mobile device 204, on the other devices by changing the meet-up location status or icon to identify the members of the group that are currently at the location or by providing a visual or audible alert. Although only one wireless network 190 is shown, it should be appreciated that wireless mobile devices may communicate through different wireless networks couples by one or more intermediary communication networks.

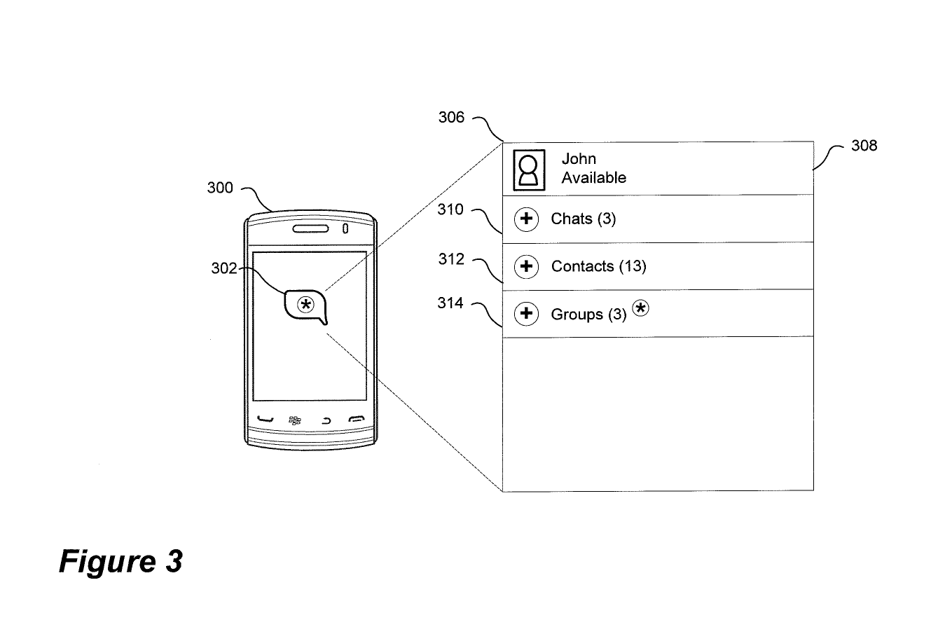

FIG. 3 shows an example device screen 306 providing an instant messaging application. The device 300 provides instant messaging application 302 executed by operating system 160. The instant messaging application 302 provides can provide an example screen 306. The user status is displayed 308, with multiple options presented to the user such as identification of active chats 310, contacts available for chats 312 and defined groups 314 comprising multiple members for conducting chats. Each item may also identify the number of items available when the item is expanded and if a change has occurred to a particular item by providing a visual indicator. The screen provided is an example screen of an application, the presentation may be varied based upon the particular messaging application.

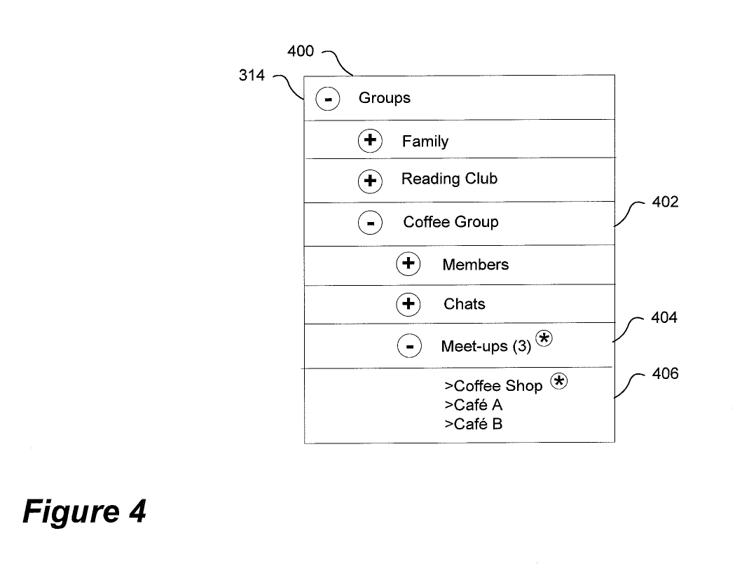

FIG. 4 shows an example device screen 400 providing an instant messaging application identifying shared meet-up locations. When a Group item 314 shown in FIG. 3 is expanded, the Groups screen may display Groups created or subscribed to by the user. For example, ‘Family’, Reading Club', and ‘Coffee Group’ 402. The ‘Coffee Group’ 402 can be expanded to identify the ‘Members’, ‘Chats’ active in the group, and ‘Meet-up’ 404 locations defined for the group. In this example three meet-up locations are defined, ‘Coffee Shop’ 406, ‘Café A’, ‘Café B’. When one or more members of the group are present at a meet-up location the number of members present can be displayed in this example three members are present at the ‘Coffee Shop’ 406. In addition when a new member arrives at the location an indicator may be displayed, such as a ‘splash’ icon ‘(*)’.

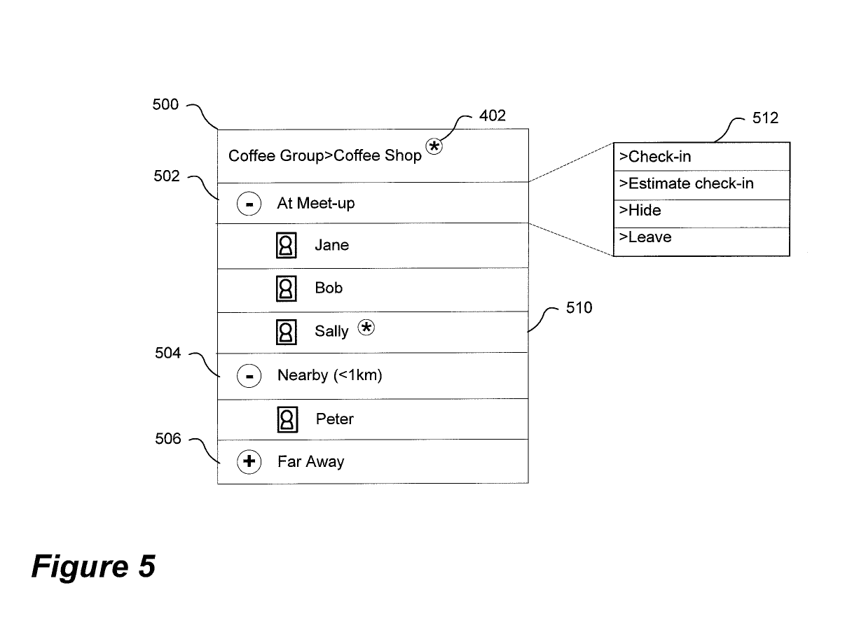

FIG. 5 shows an example device screen 500 providing an instant messaging application identifying check-in status at a shared meet-up location. Although the term ‘meet-up’ is utilized to define a meeting point, it should be understood that any number of equivalent terms may be used. In this example the ‘Coffee Shop’ 402 is expanded to show the members at the meet-up location 502. When a new member arrives at the meet-up location, since the users last view of the screen, in this case ‘Sally’ 510 an indicator, such as a ‘splash’, may be identified. Alternatively a general indicator may be provided as long as someone from the group is at the meet-up location.

Additional information may be provided in respect of each member such as the length of time that the member has been at the location. Members that are within a defined proximity or tolerance may also be identified. For example members of the group that are nearby, for example ‘<1 km’, although not at the location, may be identified relative to the meet-up location. The members may also be identified with a confidence interval indicator identifying the accuracy of the GPS location information. The indicator may be a graphic indicator such as a color change, icon change or enhancement such as a range circle defining the accuracy level. Depending on the setting of the respective user device, users that are approaching the meet-up location may also provide an estimated time of arrival. The remaining group members may be identified as ‘Far away’ 506 or not present at the meet-up location. The messaging application may also be configured only to provide location updates when the device is within a defined range of a meet-up location such that locations of devices that are out of the range, for example ‘>1 km’ may only be present as not at the location. Alternatively, locations updates may be periodically provided by members, irrespective of their location relative to designated meet-up locations so that a user location may be regularly available.

For the meet-up location additional options 512 may be presented to the user or are selectable by the user either within the screen, as a pop-up, or a menu item, to perform actions in respect of the meet-up location. The options may include but not be limited to a manual ‘check-in’ if location services are not enabled on the device, providing an ‘estimated check-in’ to other members if the user intends to arrive at the meet-up, and options for manually leaving or ‘checking out’ of the meet-up location, or selectively displaying a user status at the location to members of the group.

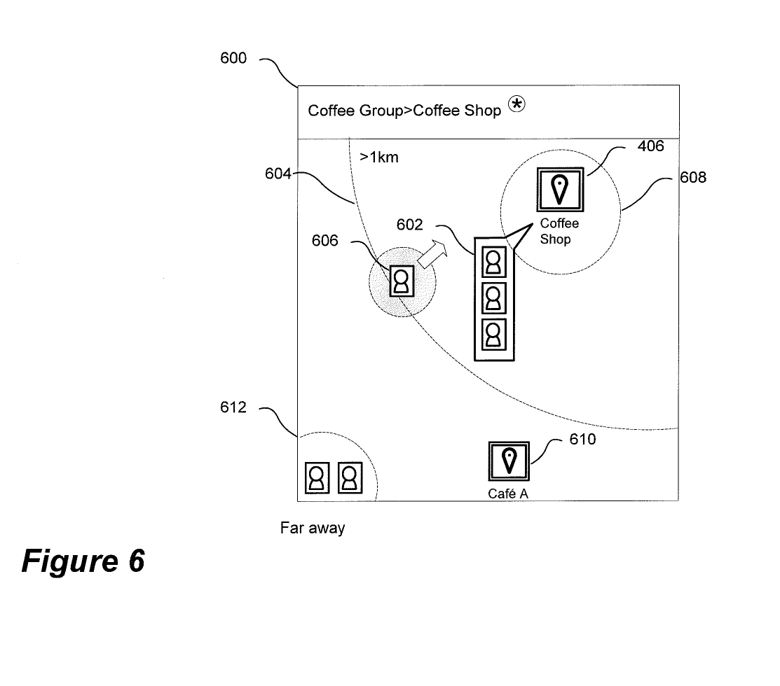

FIG. 6 shows an example device screen 600 providing an instant messaging application for selecting or identifying a shared meet-up location map. A location map 600 may be alternatively provided in the application for the location identifying the meet-up location of the ‘Coffee Shop’ 406. A graphic indication 602 may be provided to identify the members present at the meet-up location by for example avatars or pictures associated with each member. Additional indications may be provided to identify new arrivals at the location or the period of time that the member has been at the location. Other range indicators such as a radius 608 around the meet-up may be shown to identify the area defined by the meet-up location or tolerance of the area associated with the meet-up location or a location confidence interval identifying the potential inaccuracy related to the location technology utilized. The tolerance or confidence interval may be related to the positioning limitations of one or more of the devices, for example a position resolution of <100 m may not be achievable. Additional indicators a radius 604 to identify members not at the meet-up location by nearby may be identified. In this example member 606 ‘Peter’ is with 1 km of the meet-up location or approaching the meet-up location. Additional indicators associated with a user icon may be shown to identify that the member is approaching or heading to the meet-up point, for example a direction arrow. Based upon the scale, multiple meet-up points may be shown in a single screen, such as ‘Café A’ 610. An indicator of the remaining group members not within the vicinity of the meet-up location 506 may also be provided. Additional map related details may be shown such as roads, terrain, buildings, satellite imagery, pictures of the building of the meet-up location. The meet-up location may be visually identified by any number of indicators to highlight and identify the location within the map. This function may also be provided in other applications such as a social networking application or mapping application as a menu item or feature.

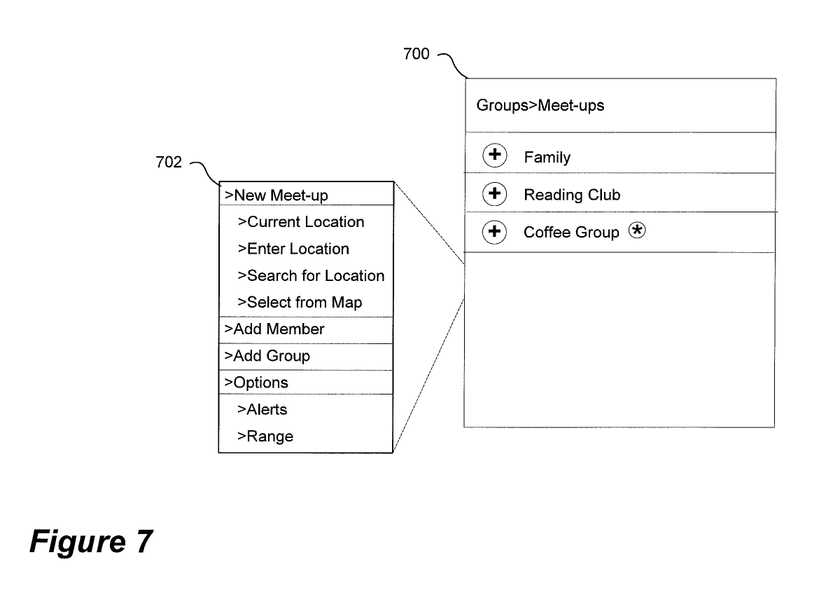

FIG. 7 shows an alternative example device screen 700 providing an instant messaging application identifying shared meet-up locations. In the meet-up screen the user may be presented, either within the screen, as a pop-up, or a menu item, to perform actions at the site such as a adding a new meet-up location 702. The new meet-up location may be based upon the current location of the device as determined by GPS, a manual location entry, a search to find a location by name, or by selection from a mapping application. New members can then be added to the meet-up or a group associated with the meet-up location. Additional options may be defined for the meet-up location such as the type of alert provided when members are at the location, a range or tolerance associated with the location to determine when members are within the location, or timers associated with determining how long a member must be at a location before alerts are issued. When configuring a meet-up location, a request is sent to each of the members identifying the location and either individual member identifiers or a group identifier. In addition the options selected by the initiating party may be provided to each member. The options may be alternatively modified by each member, for example a member may not want to be alerted about a particular member's presence at the meet-up and stored locally on the device or provided to a server.

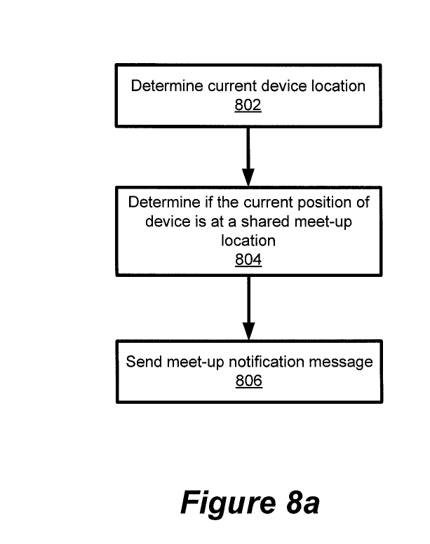

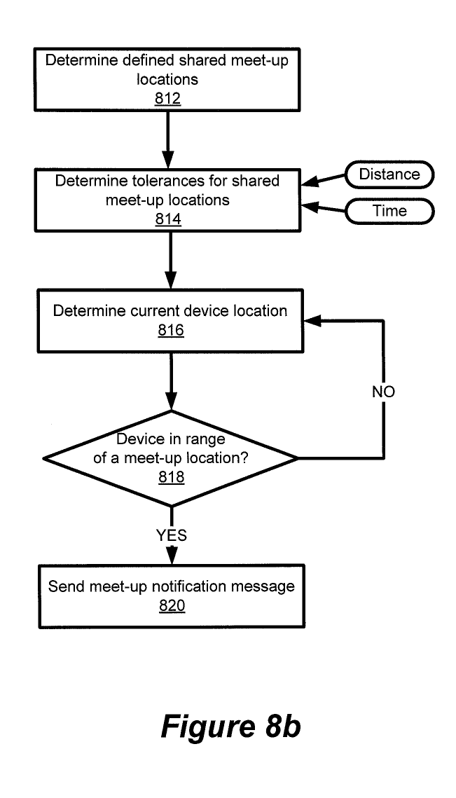

FIG. 8a shows a flow diagram illustrating a shared meet-up location check-in on a wireless mobile device. Assuming one or more meet-up locations have been configured on a device, the device position is determined (802) through one or more position determination means, such as GPS, assisted GPS, and aided GPS or by network triangulation. The position determination method may be selected as the device approaches a meet-up location, where position determination that utilizes less power may be used first with lower accuracy, but higher power consumption, higher accuracy location techniques enabled as the proximity to the meet-up location increases. When it is determined that the device is at a meet-up location (804) a meet-up notification message is sent (806) via the wireless network to the messaging server for distribution to other devices or sent directly to members devices of the group.

FIG. 8b shows an alternative flow diagram illustrating a shared meet-up location check-in on a wireless mobile device. Assuming one or more meet-up locations have been configured on a device, the shared meet-up locations are determined at associated position coordinates defined (812). The meet-up locations may be stored in a data storage area (database) associated with the application or retrieved from another application or data storage area. Optionally tolerances or variables may be associated with the meet-up location such as a distance range associated with the location point, or lengths of time, initiating a timer, that a user must be at the meet-up point before a message is sent to other members (814). The device position is determined (816) through one or more position determination means, such as GPS, assisted GPS, and aided GPS or by network triangulation. The position determination method may be selected as the device approaches a meet-up location, where position determination that utilizes less power may be used first with lower accuracy, but higher power consumption, higher accuracy position techniques enabled as the proximity to the meet-up location increases. When it is determined that the device is within range of a meet-up location (YES at 818) a meet-up notification is sent to the messaging server for distribution to other devices (820). In a peer-to-peer instant messaging environment, notifications may be sent directly to other members without an intermediary server. The notification may be based upon a meet-up identifier, a position identifier and may also include members or groups to be notified. The server may alternatively perform a look-up to determine members and/or devices that should be notified. The notification may be sent as part of a message, a custom message format, or a data or file transfer protocol. If the device is not in range of a meet-up location (NO at 818) based on position alone or on one or more of the tolerance criteria not being met, the method continues with the device determining when the device is near a meet-up location.

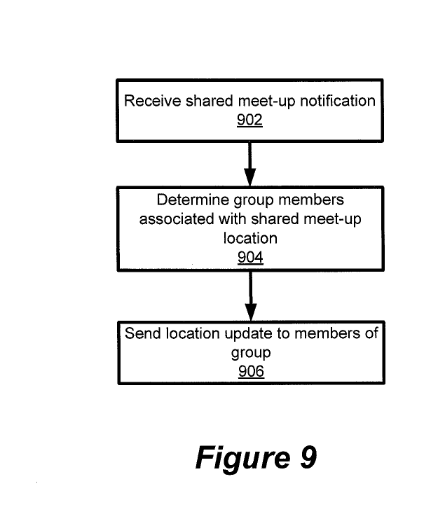

FIG. 9 shows a flow diagram illustrating a shared meet-up location check-in on an instant messaging server. The server receives a meet-up notification (902) from a device coupled to a wireless network. The meet-up notification may be a location identifier or location coordinates. The group members associated with the meet-up location identifier may be determined (904) by the server either by a look-up in database associated with the server or by identifiers provided in the location notification, defining unique users, devices, or e-mail addresses. The server then sends appropriate notifications to each of members (906) or to other IM servers associated with the member. Alternatively a look up for PIN or other device identification to determine a destination device may be performed. Sending the location update may also include unique message conversion or formatting to be compliant with the destination device or application.

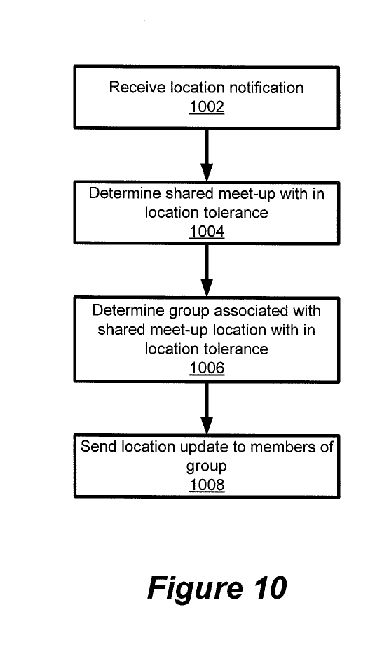

FIG. 10 shows a flow diagram illustrating an alternative shared meet-up location check-in on an instant messaging server. The server receives a meet-up notification (1002) from a device coupled to a wireless network. The meet-up notification may be a location identifier or location coordinates. If the tolerance parameters are defined at the server for the meet-up location or on an individual member level, the meet-up notification may be compared to the tolerances (1004) before a notification is sent to members of the group. For example the notifications may not be sent before a defined period of time or unless the location notification is within a defined range. Alternatively, the notification may define a number of members that must be present at a location before a notification is issued, or an order in which the members are notified. The server may also dynamically determine the notification tolerances based on learning meet-up patterns and position accuracy of member devices. The group members associated with the meet-up location identifier may be determined (1006) by the server either by a look-up in database associated with the server or by identifiers provided in the location notification, defining unique users, devices, or e-mail addresses. The server then sends appropriate notifications to each of members (1008) or to other IM servers associated with the member. Alternatively a look up for PIN or other unique device identifier may be used to determine a destination device. Sending the location may also include unique message conversion or formatting to be compliant with the destination device or application.

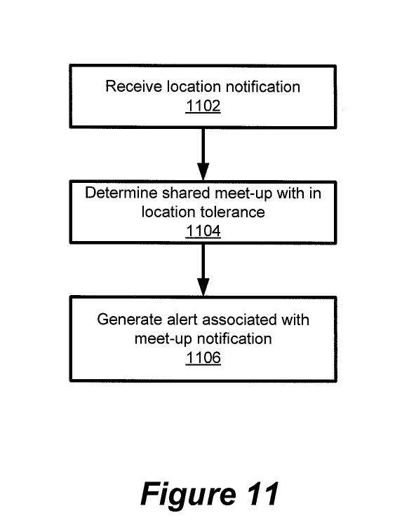

FIG. 11 shows a flow diagram illustrating a shared meet-up notification being received by a member wireless mobile device. The wireless mobile device either receives a meet-up notification directly in a peer-to-peer environment or from a member device or through the messaging server (1102). The messaging application determines the associated meet-up location and the members of the group originating the notification (1104). An alert, such as a sound, vibration, or visual indication such as a ‘splash’ icon, graphic or other identifier are then provided (1106) in the messaging application or through a user interface application programming interface (API) for displaying in other applications capable of displaying the information. The user can then select to view the meet-up location and determine which users are present at the location.

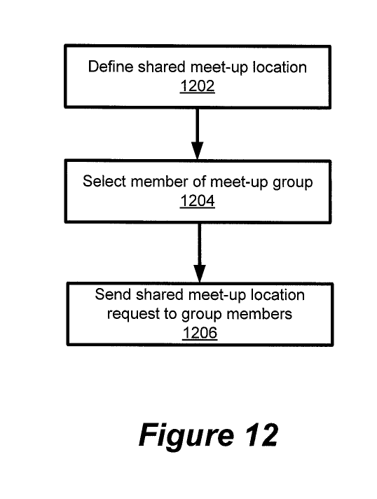

FIG. 12 shows a flow diagram illustrating a shared meet-up location request generated by an application on a wireless mobile device. When defining a new meet-up location, the user can identify the meet-up location by a number of methods. For example by using a current location of a device, selecting a location from a map in the messaging application or a map application, entering location coordinates or searching for a location (1202) from which location coordinates are determined. The group and members may be selected (1204), or they may have been selected prior to the determination of the meet-up location. The device can then send the meet-up location request to the server (1206) identifying the location coordinates, a location identifier and a group or member identifier to be invited to join the group. Users may then accept or decline the invitation with appropriate messaging being sent to each device to identify the members of the group and the meet-up location. In a peer-to-peer messaging environment the request may be sent directly to each identified member.

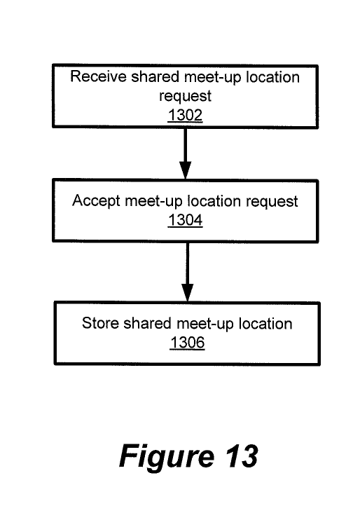

FIG. 13 shows a flow diagram illustrating a shared meet-up location request acceptance in a messaging application on a wireless mobile device. When a new meet-up location is initiated by a user the meet-up location request or invitation is sent to each member of the group for acceptance. A request is received at a device and processed by a messaging application (1302). The user may be required to accept the request, or may automatically accept any meet-up location defined for a group already subscribed to (1304). The meet-up is then stored (1306) in the application or associated memory and the respect coordinates are then utilized in location determination process.

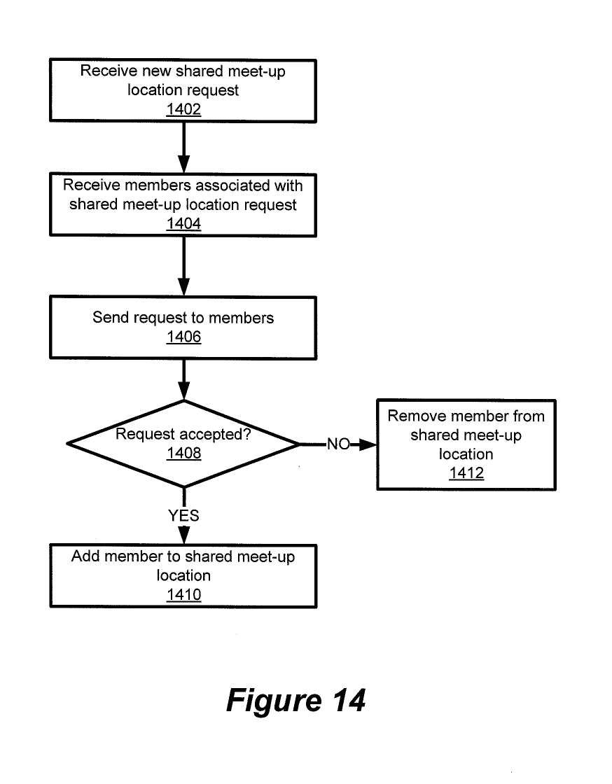

FIG. 14 shows a flow diagram illustrating a shared meet-up location request processing on a messaging server. A new meet-up location request is received (1402) at the server from a wireless mobile device via a wireless network coupled directly or indirectly to the server. The request may include location coordinates that may be then associated with a unique meet-up location identifier, or a already defined location identifier. The request may also include member or group identifiers (1404). The members or group identifier may be converted to unique device identifiers by a PIN lookup, e-mail lookup, IM identifier associated with different IM messaging protocols. A location request is sent to the members (1406) including at least the location and identification of a requesting member or group.

The request may also include tolerance criteria associated with the meet-up location for determining when the meet-up location notifications are to be issued, how the meet-up location is to be displayed, etc. (others?). If the request is accepted by a member (YES at 1408) the member is added to the meet-up location and the other accepted members can be notified of their acceptance (1410). If a member does not accept the request (NO at 1408) the member is removed from the meet-up location (1412), but not necessarily the group. Depending on configuration, a user may not be required to accept the meet-up location request and any new meet-up location requests may be automatically sent and added to each member of a pre-defined group.

Although portions of the present technology are described in the context of an instant message application, the technology may be integrated to provide functionality in any number of applications such as e-mail messaging, text messaging, mapping, social networking application or general operating system or user interface of the device to present information related to meet-up status, meet-up entry or invitations to a member.

This new technology has been described in terms of specific implementations and configurations which are intended to be exemplary only. Persons of ordinary skill in the art will, having read this disclosure, readily appreciate that many obvious variations, refinements and modifications may be made without departing from the inventive concept(s) disclosed herein. The scope of the exclusive right sought by the Applicant(s) is therefore intended to be limited solely by the appended claims.

1. A method of facilitating ad-hoc congregation using an application executed by a processor on a wireless mobile device, the method comprising:
determining a current position of the wireless mobile device;
determining if the current position of the wireless mobile device is at a shared meet-up location; and
sending a meet-up notification message via a wireless network to members defined by a group to identify that the wireless device is currently at the shared meet-up location.

2. The method of claim 1 wherein sending the meet-up notification message via the wireless network further comprises sending a group identifier.

3. The method of claim 1 wherein sending the meet-up notification message via the wireless network further comprises sending a meet-up location identifier and a member identifier.

4. The method of claim 1 wherein determining the current position of the wireless mobile device comprises acquiring position coordinates from a global positioning system (GPS) receiver coupled to the wireless mobile device.

5. The method of claim 1 wherein determining if the current position of the wireless mobile device is at a shared meet-up location further comprises applying a tolerance value to positioning coordinates of the shared meet-up location, the tolerance value used to define a range of positioning coordinates which apply to the shared meet-up location.

6. The method of claim 1 wherein determining if the current position of the wireless mobile device is at the shared meet-up location further comprises initiating a timer wherein the meet-up notification message is only sent if the timer is exceeded.

7. The method of claim 1 wherein determining the current position of the wireless mobile device comprises determining position coordinates by using wireless network triangulation techniques.

8. The method of claim 1 wherein meet-up notification messages sent via the network are sent to a messaging server, wherein the server maintains group membership information and distributes messaging to the appropriate device.

9. The method of claim 1 further comprising:
receiving, via the wireless network, an incoming meet-up notification message identifying a shared meet-up location and a member identifier;
displaying an indication on a display of the wireless mobile device of the received incoming shared meet-up notification message, the indication identifying the presence of a member of the group associated with member identifier at the shared meet-up location.

10. The method of claim 1 further comprising:
associating location coordinates with a new shared meet-up location identifier;
associating group of members with the new shared meet-up location identifier; and
sending via the wireless network the new shared meet-up location coordinates and a meet-up location identifier.

11. The method of claim 10 further comprising receiving one or more tolerance parameter associated with the new shared meet-up location wherein the tolerance parameters are sent to the messaging server.

12. The method of claim 11 wherein the tolerance parameters are selected from the group comprising: a period of time; a distance range; a time of day; and a date.

13. The method of claim 1 wherein sending the meet-up notification message through the wireless network to identify that the wireless device is at the determined shared meet-up location are sent directly to one or more member wireless mobile devices via the wireless network or one or more communications networks coupled to the wireless network.

14. A wireless mobile device comprising:
a positioning device for determining the position of the wireless mobile device;
a wireless transceiver for communicating with a wireless network;
a memory containing instructions for facilitating ad-hoc congregation using an application executed by a processor on a wireless mobile device;
a processor coupled to the location device, wireless transceiver and the memory, the processor executing an application comprising:
determining a current position of the wireless mobile device;
determining if the current position of the wireless mobile device is at a shared meet-up location; and
sending a meet-up notification message via a wireless network to members defined by a group to identify that the wireless device is currently at the shared meet-up location.

15. The wireless mobile device of claim 14 wherein the positioning device is a global positioning receiver (GPS).

16. The wireless mobile device of claim 14 wherein sending the meet-up notification message via the wireless network further comprises sending a group identifier.

17. The wireless device of claim 14 wherein sending the meet-up notification message via the wireless network further comprises sending a meet-up location identifier and a member identifier.

18. The wireless mobile device of claim 14 wherein the positioning device utilizes wireless network triangulation techniques to determine the current position of the wireless mobile device.

19. The wireless mobile device of claim 14 wherein determining if the current position of the wireless mobile device is at a shared meet-up location further comprises applying a tolerance value to positioning coordinates of the shared meet-up location, the tolerance value used to define a range of positioning coordinates which apply to the shared meet-up location.

20. The wireless mobile device of claim 14 wherein determining if the current position of the wireless mobile device is at the shared meet-up location further comprises initiating a timer wherein the meet-up notification message is only sent if the timer is exceeded

21. The wireless mobile device of claim 14 wherein meet-up notification messages sent via the network are sent to a messaging server, wherein the server maintains group membership information and distributes messaging to the appropriate device.

22. The wireless mobile device of claim 14 further comprising:
receiving, via the wireless network, an incoming meet-up notification message identifying a shared meet-up location and a member identifier;
displaying an indication on a display of the wireless mobile device of the received incoming shared meet-up notification message, the indication identifying the presence of a member of the group associated with member identifier at the shared meet-up location.

23. The wireless mobile device of claim 14 further comprising:
associating location coordinates with a new shared meet-up location identifier;
associating group of members with the new shared meet-up location identifier; and
sending via the wireless network the new shared meet-up location coordinates and a meet-up location identifier.

24. The wireless mobile device of claim 23 further comprising receiving one or more tolerance parameter associated with the new shared meet-up location wherein the tolerance parameters are sent to the messaging server.

25. The wireless mobile device of claim 24 wherein the tolerance parameters are selected from the group comprising: a period of time; a distance range; a time of day; and a date.

26. A computer readable memory containing instructions for facilitating ad-hoc congregation using an application executed by a processor on a wireless mobile device, the instructions when executed by the processor providing:
determining a current position of the wireless mobile device;
determining if the current position of the wireless mobile device is at a shared meet-up location; and
sending a meet-up notification message via a wireless network to members defined by a group to identify that the wireless device is currently at the shared meet-up location.
